(19) United States
(12) Patent Application Publication
(10) Pub. No.: US 2009/0046975 A1
(43) Pub. Date: Feb. 19, 2009

(54) Bearing Apparatus for a Wheel of Vehicle and an Axle Module Having the Bearing Apparatus

(75) Inventors: Hiroshi Kawamura, Iwata-Shi (JP); Shigeaki Fukushima, Iwata-Shi (JP); Kiyoshige Yamauchi, Iwata-Shi (JP); Masahiro Ozawa, Iwata-Shi (JP); Mitsuru Umekida, Iwata-Shi (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 12/137,771

(22) Filed: Jun. 12, 2008

Related U.S. Application Data
(63) Continuation of application No. PCT/JP2006/324861, filed on Dec. 13, 2006.

(30) Foreign Application Priority Data
Dec. 14, 2005 (JP) 2005-359918

(51) Int. Cl. F16C 19/18

(52) U.S. Cl. 384/613

(57) ABSTRACT

An axle module with a bearing apparatus has an outer joint member 14 axially secured relative to a wheel hub 1 by a caulked portion 13. The caulked portion 12 is formed by plastically deforming the end portion of a shaft portion 20 of the outer joint member 14 onto the end face 12 of the wheel hub 1. A pitch circle diameter PCDi of the inner side ball group is larger than a pitch circle diameter PCDo of the outer side ball group. The size of all the balls 6a, 6b is the same. The number of balls 6b of the inner side ball group is set larger than the number of balls 6a of the outer side ball group.

### CROSS-REFERENCE TO RELATED APPLICATIONS

This application is a continuation of International Application No. PCT/JP2006/324861, filed Dec. 13, 2006, which claims priority to Japanese Application No. 2005-359918, filed Dec. 14, 2005. The disclosures of the above applications are incorporated herein by reference.

### FIELD

The present disclosure relates to a bearing apparatus that freely rotationally supports a vehicle wheel and, more particularly, to a vehicle wheel bearing apparatus intended to reduce size and weight and to increase the rigidity and durability of the wheel bearing apparatus of a fourth generation type as well as to an axle module provided with such a wheel bearing apparatus.

### BACKGROUND

The vehicle wheel bearing apparatus is adapted to freely rotationally support a wheel hub that mounts a wheel, via a rolling bearing. Double row angular ball bearings are widely used in such a bearing apparatus. Reasons for this is that they provide desirable bearing rigidity, high durability against misalignment, and a small rotation torque in view of preferable fuel consumption.

The vehicle wheel bearing apparatus is broadly classified into a first, second, third and fourth generation structure. In the first generation structure, the double row angular wheel bearing contact ball bearing is fit between a knuckle, forming a portion of a suspension, and a wheel hub. The second generation structure has a body mounting flange or a wheel mounting flange that is directly formed on the outer circumferential surface of an outer member. The third generation structure has one of its inner raceway surfaces formed directly on the outer circumferential surface of the wheel hub. The first, second and third generation type bearing apparatus have been mass produced. In addition, the fourth generation structure has its inner raceway surfaces formed directly on the outer circumferential surfaces of the wheel hub and the constant velocity universal joint. This reduces its weight and size has been developed and partially applied to some vehicles.

One example of the wheel bearing apparatus of the fourth generation type is shown in FIG. 3. The wheel bearing apparatus includes a wheel hub 50, a double row rolling bearing 51 and a constant velocity universal joint 52. The double row rolling bearing 51 is a double row angular ball bearing. It includes an outer member 53 formed with a body mounting flange 53b on its outer circumferential surface. The body mounting flange 53b is adapted to mount onto a knuckle (not shown). The outer member 53 includes double row outer raceway surfaces 53a, 53a on its inner circumferential surface. An inner member 56 includes the wheel hub 50 and an outer joint member 55. The wheel hub 50 has a wheel mounting flange 54 integrally formed at one end. One inner raceway surface 50a is formed on the outer circumferential surface of the inner member opposite to one outer raceway surface 53a of the double row outer raceway surfaces 53a, 53a. A cylindrical portion 50b axially extends from the one inner raceway surface 50a. The outer joint member 55 is inserted into the cylindrical portion 50b of the wheel hub 50. The outer member 55 has the other inner raceway surface 55a formed on its outer circumferential surface opposite to the other outer raceway surface 53a of the double row outer raceway surfaces 53a, 53a. Double row balls 57, 57 are freely rollably contained between the outer and inner raceway surfaces and are held by cages 58, 58.

The constant velocity universal joint 52 includes an outer joint member 55, a joint inner ring 59, a cage 60 and torque transmitting balls 61. The outer joint member 55 has an integrally formed cup shaped mouth portion 62, a shoulder 63, forming a bottom of the mouth portion 62, and a shaft portion 64, axially extending from the shoulder portion 63. Torque can be transmitted via a serration 64a formed on the outer circumferential surface of the shaft portion 64 and a serration 50c formed on the inner circumferential surface of the wheel hub 50.

Seals 65, 65 are mounted in annular openings formed between the outer member 53 and the inner member 56. The seals 65, 65 prevent leakage of grease contained within the bearing apparatus and ingress of rain water or dusts into the bearing apparatus from the outside.

In addition, the amount of pre-load on bearing is controlled by plastically deforming and caulking the end of the shaft 64 of the outer joint member 55 onto an end face 67 positioned within a pilot portion 66 of the wheel hub 50 (swing caulking). Thus, the outer joint member 55 is axially secured on the wheel hub 50 and the shoulder 63 of the outer joint member 55 abuts the end face of the cylindrical portion 50b.

The contact area of the caulked portion 68 is increased to improve the strength of the caulked portion. This is done by inclining, radially outward toward the outer side, at least a portion of the end face 67 of the wheel hub 50 that the caulked portion 68 contacts (see Japanese Laid-open Patent Publication No. 356101/2002).

### SUMMARY OF THE DISCLOSURE

Recently it has become more desirable to further reduce the weight of the bearing apparatus in order to achieve improvement fuel consumption and maneuverability of the vehicle due to a reduction of an unsprung mass. In addition, it is desirable to increase the rigidity of the bearing apparatus to keep its durability and stability during running of the vehicle even when a large moment load is applied to the bearing apparatus.

It is, therefore, an object of the disclosure to provide a vehicle wheel bearing apparatus that can reduce weight and size and improve rigidity and durability of the bearing apparatus of a fourth generation type.

In order to achieve the object, a vehicle wheel bearing apparatus combination of a wheel hub, a double row rolling bearing and a constant velocity universal joint has the double row rolling bearing comprising an outer member formed with double row outer raceway surfaces on its inner circumferential surface. The outer member is formed, with a body mounting flange on its outer circumferential surface. Further, the outer member, on its outer circumferential surface at the inner side, includes a reference surface adapted to be fit by a mating member. An inner member includes the wheel hub and an outer joint member of the constant velocity universal joint. The wheel hub has a wheel mounting flange integrally formed at one end. One inner raceway surface is formed on the outer circumferential surface opposite to one outer raceway surface of the double row outer raceway surfaces. A cylindrical portion axially extends from the one inner raceway surface. The outer joint member is inserted into the wheel hub via a serration engagement. The outer joint member has the other inner raceway surface formed on its outer circumferential surface opposite to the other raceway surface of the double row outer raceway surfaces. A shaft portion is integrally formed with and axially extends from the other inner raceway surface. Balls of double row ball groups are freely rollably contained between the outer raceway surfaces and the inner raceway surfaces, respectively, of the outer member and the inner members. The outer joint member is axially secured relative to the wheel hub by a caulked portion. The caulked portion is formed by plastically deforming the end portion of the shaft of the outer joint member radially outward onto the end face of the wheel hub. A pitch circle diameter of the ball group of the inner side is larger than a pitch circle diameter of the ball group of the outer side. Further, the number of balls of the inner side ball group is set larger than the number of balls of the outer side ball group.

In the bearing apparatus of the fourth generation type, the wheel hub and the outer joint member, forming the constant velocity universal joint, are united by the caulked portion that is formed by plastically deforming the shaft end by swing caulking. Since the pitch circle diameter of the inner side ball group is larger than the pitch circle diameter of the outer side ball group, it is possible to increase the bearing span (distance between crossing points of lines of action of forces applied to both the raceway surfaces and the axis of rotation) without increasing the axial dimension of the bearing apparatus. In addition, since the number of balls of the inner side ball group is set larger than the number of balls of the outer side ball group, it is possible to reduce weight and size and to increase the bearing rigidity of the bearing apparatus. Furthermore, the larger number of balls of the inner side ball group makes it possible to increase the loading capacity of the bearing apparatus. Thus, this extends the life of the bearing apparatus. Accordingly, it is possible to provide a vehicle wheel bearing apparatus of the fourth generation type that can improve its rigidity and durability.

Preferably, the size of all the balls is same. This makes it possible to resolve erroneous assembly of the bearing apparatus. Thus, this reduces the manufacturing cost and improves the quality of the bearing apparatus.

Preferably, the end face of the wheel hub is inclined radially outward toward the outer side at a predetermined angle. This makes it possible to increase the contacting area of the caulked portion and thus to increase the strength of the caulked portion.

An axle module that comprises the above vehicle wheel bearing apparatus has a driving shaft at one end that is connected to a constant velocity universal joint of the outer side. A constant velocity universal joint is connected to the other end of the driving shaft. Thus, it is possible to reduce the unsprung mass and to simplify the assembly and disassembly of the bearing apparatus.

The outer diameter of a reference surface of an outer member is set larger than the maximum outer diameter of the constant velocity universal joint. This makes it possible to easily insert the axle module onto a knuckle forming the suspension apparatus. Thus, assembly of the axle module can be easily performed without causing interference of the boots against the knuckle.

The vehicle wheel bearing apparatus is formed of a combination of a wheel hub, a double row rolling bearing and a constant velocity universal joint. The double row rolling bearing comprises an outer member formed with double row outer raceway surfaces on its inner circumferential surface. The outer member is formed with a body mounting flange on its outer circumferential surface. The outer member on its outer circumferential surface at the inner side is formed with a reference surface adapted to be fit by a mating member. An inner member includes the wheel hub and an outer joint member of a constant velocity universal joint. The wheel hub has a wheel mounting flange integrally formed at one end. One inner raceway surface is formed on the outer circumferential surface opposite to one outer raceway surface of the double row outer raceway surfaces. A cylindrical portion axially extends from the one inner raceway surface. The outer joint member is inserted into the wheel hub via a serration engagement. The outer joint member has the other inner raceway surface formed on its outer circumferential surface opposite to the other raceway surface of the double row outer raceway surfaces. A shaft portion is integrally formed with and axially extends from the other inner raceway surface. Balls of double row ball groups are freely rollably contained between the outer raceway surfaces and the inner raceway surfaces, respectively, of the outer member and the inner members. The outer joint member is axially secured relative to the wheel hub by a caulked portion. The caulked portion is formed by plastically deforming the end portion of the shaft of the outer joint member radially outwardly onto the end face of the wheel hub. A pitch circle diameter of the inner side ball group is larger than a pitch circle diameter of the outer side ball group. Thus, it is possible to increase a bearing span (distance between crossing points of lines of action of forces applied to both the raceway surfaces and the axis of rotation) without increasing the axial dimension of the bearing apparatus. In addition, since the number of balls of the inner side ball group is set larger than the number of balls of the outer side ball group, it is possible to reduce the size and weight and to increase the rigidity of the bearing apparatus. Furthermore, the larger number of balls of the inner side ball group makes it possible to increase the loading capacity of the bearing apparatus and thus to extend the life of the bearing apparatus.

A vehicle wheel bearing apparatus combination of a wheel hub, a double row rolling bearing and a constant velocity universal joint has the double row rolling bearing comprising an outer member formed with double row outer raceway surfaces on its inner circumferential surface. The outer member is formed with a body mounting flange on its outer circumferential surface. The outer member, on its outer circumferential surface at the inner side, is formed with a reference surface adapted to be fit by a mating member. An inner member includes the wheel hub and an outer joint member of a constant velocity universal joint. The wheel hub has a wheel mounting flange integrally formed at one end. One inner raceway surface is formed on the outer circumferential surface opposite to one outer raceway surface of the double row outer raceway surfaces. A cylindrical portion axially extends from the one inner raceway surface. The outer joint member is inserted into the wheel hub via a serration engagement. The outer joint member has the other inner raceway surface formed on its outer circumferential surface opposite to the other raceway surface of the double row outer raceway surfaces. A shaft portion is integrally formed with and axially extends from the other inner raceway surface. Balls of double row ball groups are freely rollably contained between the outer raceway surfaces and the inner raceway surfaces, respectively, of the outer member and the inner members. The outer joint member is axially secured relative to the wheel hub by a caulked portion. The caulked portion is formed by plastically deforming the end portion of the shaft of the outer joint member radially outward onto the end face of the wheel hub. A pitch circle diameter of the inner side ball group is larger than a pitch circle diameter of the outer side ball group. The number of balls of the inner side ball group is set larger than the number of balls of the outer side ball group.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a longitudinal section view of a vehicle wheel bearing apparatus;

FIG. 2 is a longitudinal section view showing an axle module applied to the bearing apparatus of FIG. 1; and

FIG. 3 is a longitudinal section view of a vehicle wheel showing a bearing apparatus of the prior art.

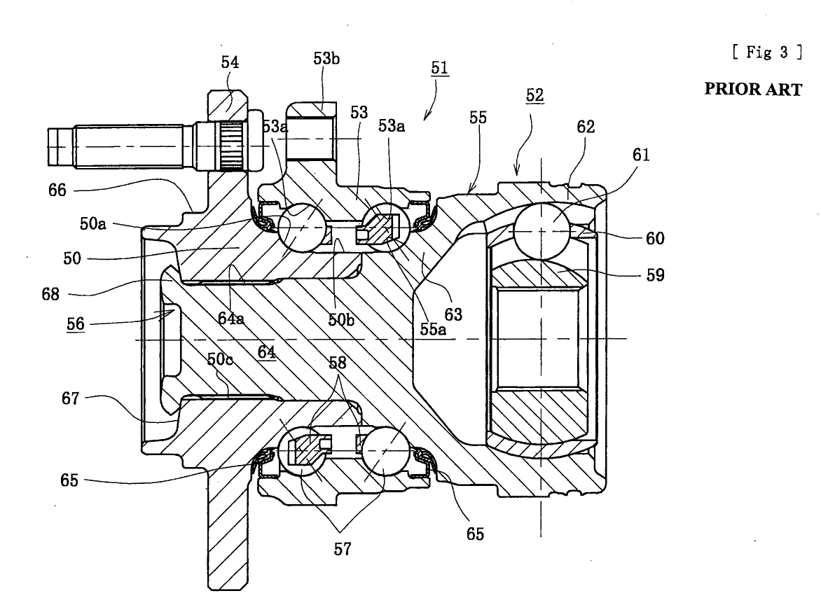

### DETAILED DESCRIPTION

A preferable embodiment of the present disclosure will be described with reference to the drawings.

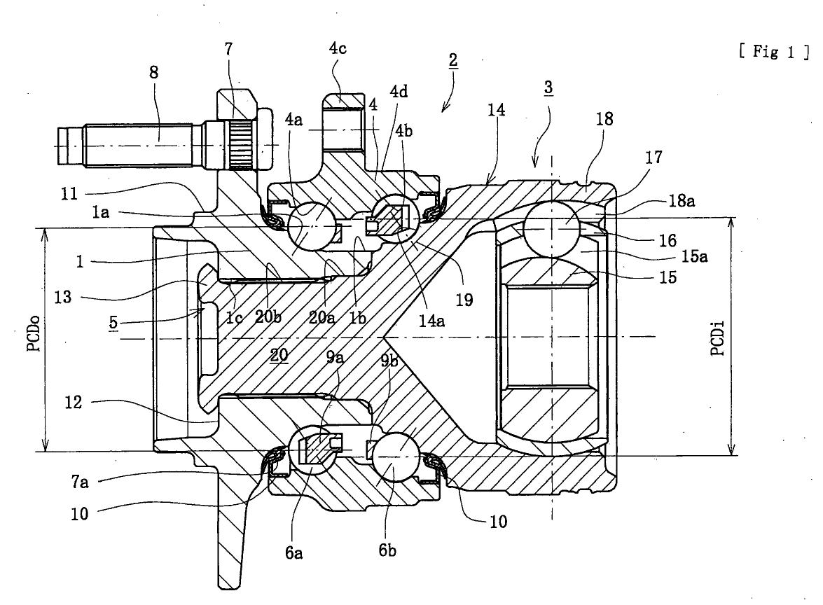

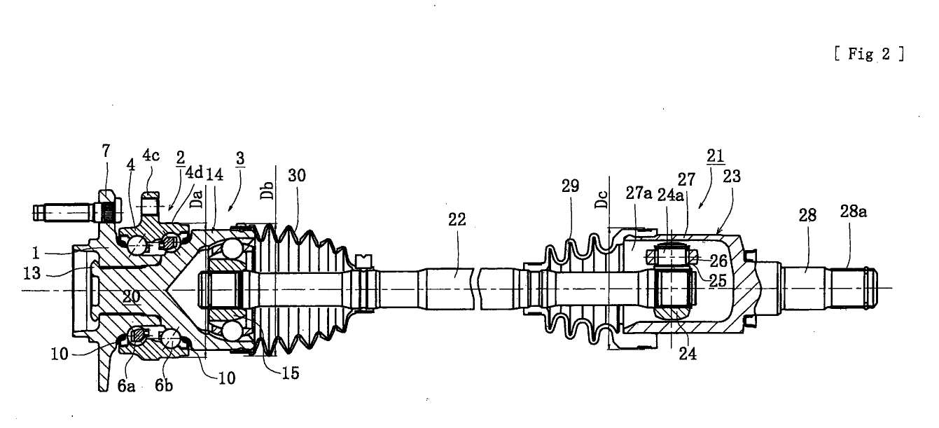

FIG. 1 is a longitudinal section view of a vehicle wheel bearing apparatus of the present disclosure. FIG. 2 is a longitudinal section view showing an axle module applying the bearing apparatus of FIG. 1. In the description below, the term “outer side” (left hand side in the drawings) of the apparatus denotes a side that is positioned outside of the vehicle body. The term “inner side” (right hand side in the drawings) of the apparatus denotes a side that is positioned inside of the body when the bearing apparatus is mounted on the vehicle body.

The vehicle wheel bearing apparatus of the present disclosure shown in FIG. 1 is a fourth generation type including a united combination of a wheel hub 1, a double row rolling bearing 2 and a constant velocity universal joint 3. The double row rolling bearing 2 includes an outer member 4, an inner member 5 and double row balls 6a, 6b. The inner member 5 includes the wheel hub 1 and an outer joint member 14, described later in more detail, that is fit into the wheel hub 1 so that torque can be transmitted between the two.

The outer member 4 is made of medium carbon steel including carbon of 0.40˜0.80% by weight such as S53C. The outer member 4 is integrally formed with a body mounting flange 4c on its outer circumferential surface. The flange is to be mounted on a knuckle (not shown) of a vehicle. The outer members inner circumferential surface has double row outer raceway surfaces 4a, 4b, each having a circular arc cross section. The double row outer raceway surfaces 4a, 4b are hardened by high frequency induction quenching to have a surface hardness of 58˜64 HRC.

The wheel hub 1 is made of medium carbon steel including carbon of 0.40˜0.80% by weight such as S53C. The wheel hub 1 has a wheel mounting flange 7 on its outer side end portion. A plurality of hub bolts 8 are mounted on the wheel mounting flange equidistantly spaced along its periphery. The wheel hub 1 is formed with one circular arc inner raceway surface 1a on its outer circumferential surface opposite an outer side (4a) of the outer raceway surfaces 4a, 4b. The wheel hub 1 has a cylindrical portion 1b that axially extends from the inner raceway surface 1a. A serration (or spline) 1c is on its inner circumferential surface for torque transmission. A region from a seal land portion 7a, on which an outer side seal 10 slides, to the inner raceway surface 1a and the cylindrical portion 1b is hardened by high frequency induction quenching to have a surface hardness of 58˜64 HRC. This improves not only the wear resistance of the seal land portion 7a at the base of the wheel mounting flange 7 but the mechanical strength against a rotary bending load applied to the wheel mounting flange 7. Thus, this improves the durability of the wheel hub 1.

The constant velocity universal joint 3 includes the outer joint member 14, a joint inner ring 15, a cage 16 and torque transmitting balls 17. The outer joint member 14 is made of medium carbon steel including carbon of 0.40˜0.80% by weight such as S53C. The outer joint member 14 is integrally formed with a cup shaped mouth portion 18, a shoulder 19 forming a bottom of the mouth portion 18, and a shaft portion 20 axially extending from the shoulder portion 19. The shaft portion 20 is formed with a cylindrical spigot portion 20a that is fit into the cylindrical portion 1b of the wheel hub 1 via a predetermined radial gap. A serration (or spline) 20b is formed on the spigot that engages the serration 1c of the wheel hub.

The mouth portion 18 is formed with curved track grooves 18a on its inner circumferential surface. The joint inner ring 15 is formed with track grooves 15a corresponding to the track grooves 18a on its outer circumferential surface. The torque transmitting balls 17 are contained between the track grooves 18a, 15a and are held by the cage 16. An inner side inner raceway surface 14a, having a circular arc cross section, is formed on the outer circumferential surface of the shoulder portion 19 opposite to the outer raceway surface 4. The track grooves 18a, a region from a circumferential surface on which the inner side seal 10 is fit to the inner raceway surface 14a, and the shaft portion 20 are hardened by high frequency induction quenching so as to have a surface hardness of 58˜64 HRC.

Double row balls 6a, 6b are contained between the outer raceway surfaces 4a, 4b of the outer member 4 and the opposing double row inner raceway surfaces 1a, 14a. The balls 6a, 6b are freely rollably held by cages 9a, 9b. Seals 10, 10 are arranged on opposite ends of the outer member 4. The seals 10, 10 prevent leakage of lubricating oil contained in the bearing and ingress of rain water or dusts into the bearing from the outside. The double row rolling bearing 2 is a double row angular contact ball bearing of a so-called back-to-back duplex bearing type.

A method for uniting the wheel hub 1, the double row rolling bearing 2 and the constant velocity universal joint 3 will be described in more detail.

First of all, the double row balls 6a, 6b are temporary assembled onto the double row outer raceway surfaces 4a, 4b of the outer member 4 via the cages 9a, 9b. The seals 10, 10 are mounted on opposite ends of the outer member 4. The wheel hub 1 and the outer joint member 14 are inserted into the outer member 4 from either side. The shaft portion 20 of the outer joint member 14 is inserted into the wheel hub 1, via serrations 1c, 20b, until the shoulder portion 19 of the outer joint member 14 abuts the end face of the cylindrical portion 1b of the wheel hub 1. The end portion of the shaft portion 20 is plastically deformed radially outwardly and caulked onto the end face 12 positioned within a pilot portion 11 of the wheel hub 1. Accordingly, the outer joint member 14 is axially secured on the wheel hub 1 by a caulked portion 13. The pre-load of the bearing can be controlled at a predetermined amount. Accordingly, the pre-load control performed by strongly fastening a nut in the prior art can be eliminated. Thus, it is possible to reduce the weight and size of the bearing apparatus, to improve the strength and durability of the wheel hub 1 and to keep the amount of pre-load for a long term.

An end cap (not shown) may be mounted on an opening of the wheel hub 1 to prevent ingress of rain water and dust etc. and thus the generation of rust in the plastically deformed caulked portion 13. In order to increase the strength of the caulked portion 13, at least a portion of the end face 12 of the wheel hub 1, to which the caulked portion 13 contacts. may be inclined at a predetermined angle. The end face is inclined radially outwardly toward the outer side to increase the contacting area between the caulked portion 13 and the end face 12.

In the illustrated embodiment, a pitch circle diameter PCDi of the inner side ball group 6b is larger than a pitch circle diameter PCDo of the outer side ball group 6a. Since the outer diameter of each ball 6a is same as that of ball 6b, the number of balls 6b of the inner side ball group is set larger than the number of balls 6a of the outer side ball group. This makes it possible to solve erroneous assembly of the bearing apparatus. Thus, this reduces the manufacturing cost and improves the quality of the bearing apparatus.

Due to the difference in the pitch circle diameter PCDi of balls 6b and the pitch circle diameter PCDo of the balls group 6a, the diameter of the bottom of the inner raceway surface 14a of the outer joint member 14 is formed larger than that of the inner raceway surface 1a of the wheel hub 1. Similarly in the outer member 4, the diameter of the bottom of the outer raceway surface 4b of the inner side is formed larger than that of the outer raceway surface 4a of the outer side.

FIG. 2 is a longitudinal section view of an axle module applied to the bearing apparatus of FIG. 1. The axle module includes a pair of constant velocity universal joints 3, 21. A driving shaft 22 connects the constant velocity universal joints 3, 21. One end of the driving shaft 22 is inserted into the joint inner ring 15 of the outer side constant velocity universal joint 3, via a serration engagement. The other end of the driving shaft 22 is connected to the inner side constant velocity universal joint 21, that is adapted to connect to a differential apparatus (not shown).

The inner side constant velocity universal joint 21 includes an outer joint member 23, a tripod member 24 on which outer circumferential surface three leg shaft 24a are equidistantly arranged, and rollers 26 rotationally mounted on the leg shaft 24a via needle rollers 25. The outer joint member 23 is a unitary body made of medium carbon steel including carbon of 0.40˜0.80% by weight such as S53C. The outer joint member 23 includes a hollow cylindrical portion 27 and a shaft portion 28 that extends from the bottom of the cylindrical portion 27. The shaft portion 28 is formed with serration (or spline) 28a on its outer circumferential surface. The serrations 28 connect to the differential apparatus.

Three axially extending straight track grooves 27a are formed on the inner circumferential surface of the cylindrical portion 27. Rollers 26 roll on the track groove 27a. The surfaces of the track grooves 27a are hardened by high frequency induction quenching to form a predetermined hardened layer. An opening of the cylindrical portion 27 is covered by a synthetic rubber boot 29. The boot 29 prevents leakage of grease contained in the cylindrical portion 27 and ingress of rain water and dusts from the outside.

The configuration of the cylindrical portion 27 may be a petal shaped cross section corresponding to the track grooves 27a other than a circle. The shaft portion 28 may be integrally formed with a mounting flange to be connected to the differential apparatus. Although, for example, the inner side constant velocity universal joint 21 is shown as a tripod type, any sliding type constant velocity universal joint may be used. For example, other tripod type joints having a different structure and a double offset type constant velocity universal joint (DOJ) may be used.

In the illustrated embodiment, the outer diameter Da of a reference surface 4d of the outer member 4, that is to be fit into a knuckle of a vehicle, is larger than the maximum outer diameter Db, Dc, respectively, of the constant velocity universal joint 3, 21. In this embodiment, the maximum outer diameter of the boots 30, 29, is (Da>Db≧Dc). Not only does this enable a reduction of the unsprung mass it accordingly achieves easy assembly and disassembly of the unit to and from the vehicle body. Additionally, it achieves easy insertion of the axle module into the knuckle and easy assembly of boots 30, 29 without damage by interference of the knuckle.

The vehicle wheel bearing apparatus of the present disclosure can be applied to any bearing apparatus of the fourth generation type where the wheel hub, the double row rolling bearing and the constant velocity universal joint are united with each other.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or equivalents.

What is claimed is:

1. A vehicle wheel bearing apparatus of an united combination of a wheel hub, a double row rolling bearing and a constant velocity universal joint, said double row rolling bearing comprises:
an outer member formed with double row outer raceway surfaces on its inner circumferential surface, a body mounting flange on said outer member outer circumferential surface, and a reference surface at an inner side of said outer member on its outer circumferential surface, said reference surface adapted to be fit by a mating member;
an inner member including the wheel hub and an outer joint member of said constant velocity universal joint, said wheel hub having a wheel mounting flange integrally formed at one end, one inner raceway surface formed on the outer circumferential surface opposite to one outer raceway surface of the double row outer raceway surfaces and a cylindrical portion axially extending from the one inner raceway surface, said outer joint member being inserted into the wheel hub via a serration engagement, said outer joint member having the other inner raceway surface formed on its outer circumferential surface opposite to the other raceway surface of the double row outer raceway surfaces, and a shaft portion integrally formed with and axially extending from the other inner raceway surface;
balls of double row ball groups are freely rollably contained between the outer raceway surfaces and the inner raceway surfaces respectively, of the outer member and the inner members;
said outer joint member is axially secured relative to the wheel hub by a caulked portion, said caulked portion formed by plastically deforming an end portion of the shaft of the outer joint member radially outward onto an end face of the wheel hub; and
a pitch circle diameter of an inner side ball group is larger than a pitch circle diameter of an outer side ball group, and a number of balls of the inner side ball group is set larger than a number of balls of the outer side ball group.

2. The vehicle wheel bearing apparatus of claim 1 wherein all the balls have the same size.

3. The vehicle wheel bearing apparatus of claim 1 wherein the end face of the wheel hub is inclined at a predetermined angle radially outward toward the outer side.

4. An axle module comprising a vehicle wheel bearing apparatus of claim 1 and comprising, a driving shaft with one end being connected to a constant velocity universal joint of the outer side, and a constant velocity universal joint connected to the other end of the driving shaft.

5. The axle module of claim 4 wherein the outer diameter of a reference surface of an outer member is set larger than the maximum outer diameter of said constant velocity universal joint.
